(19) United States
(12) Patent Application Publication
(10) Pub. No.: US 2014/0203787 A1
(43) Pub. Date: Jul. 24, 2014

(54) NONAQUEOUS ELECTROLYTE SECONDARY BATTERY

(71) Applicant: Satoshi Yamamoto, Tokushima (JP)

(72) Inventor: Satoshi Yamamoto, Tokushima (JP)

(73) Assignee: SANYO ELECTRIC CO., LTD., Moriguchi-shi, Osaka (JP)

(21) Appl. No.: 14/232,560

(22) PCT Filed: Jul. 25, 2012
(86) PCT No.: PCT/JP2012/068796

§ 371 Date: Jan. 13, 2014

(30) Foreign Application Priority Data
Jul. 29, 2011 (JP) 2011-167620

(51) Int. Cl. H01M 4/52; H02J 7/00

(52) U.S. Cl. CPC H01M 4/52; H02J 7/0052
USPC 320/137; 429/223

(57) ABSTRACT

A nonaqueous electrolyte secondary battery contains 1% by mass or larger of a lithium nickel cobalt manganese oxide represented by LiₐNiₓCo_{y}Mn_{1-x-y}O₂ (0.9≦a≦1.1, 0<x<1, 0<y<1, 2x≧1−y) as a positive electrode active material, and a positive electrode active material mixture layer contains 0.01 to 3.0% by mass of a molybdenum oxide (MoO_{z}; 2≦z≦3) with respect to the lithium nickel cobalt manganese oxide. The nonaqueous electrolyte secondary battery exhibits excellent charge-discharge cycling characteristics under high temperature even with high charging voltage.

### TECHNICAL FIELD

The present invention relates to a nonaqueous electrolyte secondary battery, and particularly relates to a nonaqueous electrolyte secondary battery that contains a lithium nickel cobalt manganese oxide as a positive electrode active material and a molybdenum oxide in a positive electrode active material mixture and has excellent high-temperature cycling characteristics even with high charging voltage.

### BACKGROUND ART

As a power supply for driving mobile electronic instruments and further as a power supply for hybrid electric vehicles (HEVs) or electric vehicles (EVs), nonaqueous electrolyte secondary batteries, represented by lithium-ion secondary batteries, are extensively utilized.

As a positive electrode active material of these nonaqueous electrolyte secondary batteries, lithium transition-metal composite oxides represented by LiMO₂ (M is at least one kind of Co, Ni, and Mn), which are capable of reversibly absorbing and desorbing lithium ions, are used. That is, a single one of or a mixture of a plurality of LiCoO₂, LiNiO₂, LiNi_{y}Co_{1-y}O₂ (y=0.01 to 0.99), LiMnO₂, LiCoₓMn_{y}Ni_{z}O₂ (x+y+z=1), LiMn₂O₄, and LiFePO₄, is used.

Of these, lithium-cobalt composite oxides and lithium-cobalt composite oxides with dissimilar metal elements added thereto are commonly used because they are superior to other materials in battery characteristics. However, cobalt is expensive, and the existing amount as a resource is small. For this reason, research and development have been intensively pursued for lower-priced materials for the positive electrode active material, such as lithium nickel cobalt manganese oxides, as a substitute for lithium cobalt oxides.

For example, Patent Document 1 discloses a technology that achieves improvement in both thermostability and discharge capacity, in which a positive electrode material is obtained by mixing a fluorine-added lithium-nickel-cobalt-manganese composite oxide represented by LiNi_{1-x-y}CoₓMn_{y}O₂ (where conditions of 0.5<x+y<1.0 and 0.1<y<0.6 are satisfied) and a lithium-manganese composite oxide represented by Li₍₁₊ₐ₎Mn_{2-a-b}M_{b}O₄ (where M is at least one kinds of elements selected from the group of Al, Co, Ni, Mg, and Fe, and conditions of 0≦a≦0.2 and 0≦b≦0.1 are satisfied) that has a spinel structure.

Patent Document 2 discloses that, in a nonaqueous electrolyte secondary battery in which a film is formed on the surface of a carbon material as a negative active material by causing a particular cyclic carbonate to be contained within the nonaqueous electrolyte so as to improve the charge-discharge cycling characteristics, a nonaqueous electrolyte secondary battery with improved output characteristics and charge-discharge cycle life can be obtained by combining a lithium-manganese composite oxide and a lithium-nickel-cobalt-manganese composite oxide as a positive electrode active material, the lithium-manganese composite oxide being represented by composition formula LiₓMn_{2-y1}M1_{y2}O₄₊ₓ(M1 is at least one element selected from the group consisting of Al, Co, Ni, Mg, and Fe, and conditions of 0≦x≦1.5, 0≦y1≦1.0, 0≦y2≦0.5, and −0.2≦z≦0.2 are satisfied in the formula) having a spinel structure, and the lithium-nickel-cobalt-manganese composite oxide being represented by composition formula LiₐNi_{b}Co_{c}Mn_{d}O₂ (where conditions of 0≦a≦1.2 and b+c+d=1 are satisfied).

### RELATED ART DOCUMENT

### Patent Document

[Patent Document 1] JP-A-2005-267956

[Patent Document 2] JP-A-2004-146363

[Patent Document 3] JP-A-2000-106174

### DISCLOSURE OF INVENTION

### Problem to be Solved by the Invention

There is a need for development of nonaqueous electrolyte secondary batteries that has a low cost and a high capacity due to increased power consumption and the need for long-duration drive that comes with the enriched entertainment functions of recent mobile information terminals, such as functions for video replay and games. Developments have therefore been pursued concerning technologies that relate to increasing the capacity of a nonaqueous electrolyte secondary battery containing a lithium nickel cobalt manganese oxide, which is lower in price than a lithium cobalt oxide, as a positive electrode active material.

Methods of increasing the capacity of the nonaqueous electrolyte secondary battery may include the following:

(1) increasing the capacity of active materials;

(2) increasing the charging voltage; and

(3) increasing the packing amount and packing density of active materials.

A nonaqueous electrolyte secondary battery with increased charging voltage generally has problems of decreased cycling characteristics and increased battery thickness due to gas generation. The inventors of the present invention examined the cycling characteristics under high-temperature conditions, with a lithium nickel cobalt manganese oxide contained as a positive electrode active material and the charging potential of the positive electrode set higher than 4.4 V relative to the Li reference. As a result, a decrease in capacity at an initial cycle stage was smaller than in a case of using a lithium cobalt oxide, but, meanwhile, the capacity drastically decreased after a certain number of cycles.

The inventors of the present invention further analyzed the batteries used in the examination of the cycling characteristics. As a result, the lithium nickel cobalt manganese oxide as the positive electrode active material provided a smaller amount of dissolving transition metals in the electrolyte than the lithium cobalt oxide, but provided a larger amount of gas generation due to electrolyte degradation and a larger amount of precipitation of metal lithium on the negative electrode.

The results of the examination and analysis lead to the following presumption for the reason why the charge-discharge cycling characteristics was obtained in the case of using the lithium nickel cobalt manganese oxide as the positive electrode active material. Specifically, the reason why a decrease in capacity at an initial cycle stage was smaller in the case of the lithium nickel cobalt manganese oxide is presumed to be the smaller amount of the dissolving transition metal components and a smaller decrease in the capacity of the positive electrode active material. Meanwhile, however, the larger amount of gas generation in the case of the lithium nickel cobalt manganese oxide indicates occurrence of a side reaction at the time of charging, which results in excess charging on the negative electrode compared with the positive electrode.

The excess charging amount, which does not contribute to discharge, accumulates on the negative electrode side as an irreversible capacity. In nonaqueous electrolyte secondary batteries, the charging capacity of the negative electrode is originally designed to be larger than that of the positive electrode. However, the irreversible capacity gradually increased on the negative electrode side, as mentioned above, causes a collapse in the capacity balance after a certain number of cycles in which the charging capacities of the positive and negative electrodes are reversed. Consequently, metal lithium precipitates on the negative electrode side at the time of charging after a certain number of cycles, which causes the drastic decrease in the capacity.

In view of the above-mentioned problems, the present invention provides a nonaqueous electrolyte secondary battery that contains a lithium nickel cobalt manganese oxide as a positive electrode active material and has excellent high-temperature cycling characteristics even when the charging potential of the positive electrode is set higher than 4.4 V relative to the Li reference.

Patent Document 3 discloses an invention of a nonaqueous electrolyte secondary battery in which a positive electrode mixture paste contains a positive electrode active material reversibly reacting with lithium, such as LiCoO₂, LiNiO₂, LiMnO₂, and LiMn₂O₄, as a main component and exhibits alkaline, and the positive electrode mixture paste is applied onto a metal collector having corrosiveness against alkali. In the nonaqueous electrolyte secondary battery, MoO₃ is added at a weight ratio of 100 to 10000 ppm relative to the positive electrode active material.

In Patent Document 3, MoO₃ is added to the positive electrode active material paste for restraining corrosion of the metal collector and increasing attachment of the positive electrode active material paste. There is no discussion on high-temperature cycling characteristics in a case of adding a particular amount of a molybdenum oxide to the positive electrode active material mixture, with a lithium nickel cobalt manganese oxide contained as a positive electrode active material and the charging potential of the positive electrode set higher than 4.4 V relative to the Li reference.

### Means for Solving Problem

A nonaqueous electrolyte secondary battery of the invention includes: a positive electrode plate including a positive electrode active material mixture layer that contains a positive electrode active material capable of absorbing and desorbing lithium ions; a negative electrode plate including a negative electrode active material mixture layer that contains a negative electrode active material capable of absorbing and desorbing lithium ions; and a nonaqueous electrolyte. In the nonaqueous electrolyte secondary battery, the positive electrode active material contains 1% by mass or larger of a lithium nickel cobalt manganese oxide represented by LiₐNiₓCo_{y}Mn_{1-x-y}O₂ (0.9≦a≦1.1, 0<x<1, 0<y<1, 2x≧1−y); and the positive electrode active material mixture layer contains 0.01 to 3.0% by mass of a molybdenum oxide (MoO_{z}; 2≦z≦3) with respect to the lithium nickel cobalt manganese oxide.

With the nonaqueous electrolyte secondary battery of the invention, a nonaqueous electrolyte secondary battery that has excellent high-temperature cycling characteristics can be obtained, in which a side reaction in charging is prevented, the capacity retention ratio after a charge-discharge cycle under high-temperature conditions is increased, and an increase in the battery thickness is kept small, even when a lithium nickel cobalt manganese oxide is contained as the positive electrode active material and the charging potential of the positive electrode is set higher than 4.4 V relative to the Li reference.

It is presumed that the above-mentioned advantages of the invention result from the following mechanisms. Specifically, molybdenum dioxide, molybdenum trioxide, and non-stoichiometric compounds thereof each have its reaction potential of about 1.0 to 2.5 V relative to the Li reference. The molybdenum oxide mixed in the positive electrode active material mixture therefore dissolves slowly and chemically, while it does not contribute to the charge-discharge reaction.

Molybdenum ions in the electrolyte disperse toward the negative electrode side, and are then reduced at the negative electrode. This reduction reaction prevents a collapse in the capacity balance due to gas generation at the positive electrode, in which the capacity ratio of the positive electrode and the negative electrode (=negative electrode charging capacity/positive electrode charging capacity) falls below 1. That is, the dissolution and precipitation of the molybdenum oxide provides an effect of reducing the excess charging amount accumulated on the negative electrode side and thus prevents a collapse in the capacity balance, thereby improving the cycling characteristics.

Regarding precipitation patterns of positive ions of metal, precipitation in a concentrated manner occurs when the growth reaction proceeds faster than the nucleation reaction, whereas precipitation in a relatively dispersed manner occurs when the nucleation reaction proceeds faster than the growth reaction. The precipitation patters vary among elements (ion species): for example, copper ions and nickel ions are likely to precipitate in a concentrated manner

Such concentrated precipitation blocks active sites of the negative electrode and inhibits lithium intercalation reactions. Further proceeding, the precipitation penetrates through the separator, which causes a local short circuit of the positive and negative electrodes. With the battery in this state, normal charge and discharge cannot be performed.

In contrast, molybdenum precipitates in a dispersed manner. Consequently, the active sites of the negative electrode are unlikely to be blocked, and the intercalation reactions are unlikely to be inhibited. Thus, not any oxide can be mixed into the positive electrode mixture, and the precipitation pattern should be taken in consideration. In this regard, molybdenum oxides are considered superior to other oxides or metals.

For the same reason as above, the molybdenum oxide mixed in the positive electrode material is preferably in a uniformly dispersed state, and preferably has an appropriately small particle diameter. Specifically, in a particle size distribution measured with laser diffraction, D50 is preferably 5 to 10 μm, and D90 is preferably 30 μm or smaller.

The lithium nickel cobalt manganese oxide has a lower true density than the lithium cobalt oxide, consequently being inferior in packing properties. For this reason, it is advantageous to use a mixture of the lithium nickel cobalt manganese oxide and at least one kind of lithium cobalt oxide, lithium nickel oxide, and lithium nickel cobalt oxide, which have high packing properties, for achieving both high energy density and cost cutting of the positive electrode active material.

As the negative electrode active material of the invention, a material capable of reversibly absorbing and desorbing lithium ions can be used, such as a carbonaceous substance such as graphite and coke, and a metal capable of alloying with lithium, such as tin oxide, metal lithium, and silicon, and alloys thereof. Of these, it is preferable to use graphite. A material containing copper or copper alloy can be used for the negative electrode substrate.

The positive electrode mixture of the invention may contain, for example, a conducting agent and a binding agent that have been commonly used. A material containing aluminum or aluminum alloy can be used for the positive electrode substrate.

The following can be used as a nonaqueous solvent for the nonaqueous electrolyte of the invention: a cyclic carbonate such as ethylene carbonate (EC), propylene carbonate (PC), and butylene carbonate (BC); a fluorinated cyclic carbonate; a cyclic carboxylate ester such as γ-butyrolactone (BL) and γ-valerolactone (VL); a chain carbonate such as dimethyl carbonate (DMC), ethyl methyl carbonate (EMC), diethyl carbonate (DEC), methylpropyl carbonate (MPC), and dibutyl carbonate (DBC); a fluorinated chain carbonate; a chain carboxylate ester such as methyl pivalate, ethyl pivalate, methyl isobutyrate, and methyl propionate; an amide compound such as N,N′-dimethylformamide and N-methyl oxazolidinone; a sulfur compound such as sulfolane; and an ambient-temperature molten salt such as 1-ethyl-3-methylimidazolium tetrafluoroborate. It is desirable that two or more of them be mixed to be used. In particular, to increase the ion conductivity, it is preferable to use a mixture of a cyclic carbonate, which is high in the dielectric constant, and a chain carbonate, which is low in viscosity.

Within the nonaqueous electrolyte in the invention, the following compounds may be further added as compounds for stabilization of an electrode: vinylene carbonate (VC), vinyl ethyl carbonate (VEC), succinic anhydride (SUCAH), maleic anhydride (MAAH), glycolic anhydride, ethylene sulfite (ES), divinyl sulfone (VS), vinyl acetate (VA), vinyl pivalate (VP), catechol carbonate, and biphenyl (BP). Two or more of these compounds can also be mixed for use as appropriate.

In the invention, a lithium salt that is commonly used as an electrolyte salt for a nonaqueous electrolyte secondary battery may be used as an electrolyte salt dissolved in the nonaqueous solvent. Examples of such a lithium salt are as follows: LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and mixtures of these substances. In particular, it is preferable that LiPF₆ (lithium hexafluorophosphate) be used among them. The amount of dissolution of the electrolyte salt with respect to the nonaqueous solvent is preferably 0.8 to 1.5 mol/L.

In the nonaqueous electrolyte secondary battery of the invention, the nonaqueous electrolyte may be not only in liquid form but also in a gel.

### BRIEF DESCRIPTION OF DRAWINGS

FIG. 1 is a graph showing the relation between the number of cycles and the capacity retention ratio of Example 1 and Comparative Example 1.

FIG. 2 is a graph showing the relation between the number of cycles and the capacity retention ratio of Comparative Examples 5 and 6.

### BEST MODES FOR CARRYING OUT THE INVENTION

An embodiment for carrying out the present invention will be described below in detail using examples and comparative examples. The examples below show examples of a nonaqueous electrolyte secondary battery for embodying the technical idea of the present invention and is not intended to specify the present invention as the examples. The present invention is equally applicable to various modifications without departing from the technical idea shown in the scope of claims.

### EXAMPLE 1

### [Positive Electrode Active Material]

A lithium nickel cobalt manganese oxide as a positive electrode active material was obtained as follows. As starting materials, lithium hydroxide (LiOH.H₂O) was used as a lithium source, and a coprecipitated hydroxide of nickel, cobalt, and manganese (Ni_{0.33}Co_{0.34}Mn_{0.33}(OH)₂) was used as a transition metal source. These materials were weighed and mixed so as to give a molar ratio of 1:1 between lithium and transition metals (nickel, cobalt, and manganese). A mixture thus obtained was baked at 400° C. for 12 hours in an oxygen atmosphere. The resultant substance was crushed with a mortar, and was further baked at 900° C. for 24 hours in an oxygen atmosphere. The lithium nickel cobalt manganese oxide was thus obtained. The lithium nickel cobalt manganese oxide was crushed with a mortar to have the average particle diameter of 15 μm, thereby preparing the positive electrode active material used in this example. The chemical composition of the lithium nickel cobalt manganese oxide was measured using an inductively coupled plasma (ICP) emission spectrometry.

[Preparation of Positive Electrode Active Material Mixture Slurry]

Molybdenum trioxide (MoO₃) was added at 0.1% by mass with respect to the lithium nickel cobalt manganese oxide thus obtained as the positive electrode active material and was then mixed, thereby obtaining a mixture of the positive electrode active material and molybdenum trioxide.

A positive electrode active material mixture slurry was prepared by mixing 96 parts by mass of the mixture, 2 parts by mass of carbon powder as a conducting agent, and 2 parts by mass of polyvinylidene fluoride (PVdF) powder as a binding agent, and mixing the resultant substance with an N-methylpyrrolidone (NMP) solution.

[Preparation of Positive Electrode Plate]

The positive electrode active material mixture slurry obtained as above was applied by the doctor blade method to both surfaces of a positive electrode substrate of aluminum with a thickness of 15 μm as follows: the applied weights on one surface was 21.2 mg/cm²; the applied weight on both surfaces was thus 42.4 mg/cm²; one surface had an applied portion of 277 mm and a bare portion of 57 mm; and the other surface had an applied portion of 208 mm and a bare portion of 126 mm Subsequently, the resultant object was dried through a drying machine, thereby forming a positive electrode active material layer on both surfaces of the positive electrode substrate. The resultant object was then compressed with a compression roller so that the thickness of the applied portions on both surfaces was 132 μm, thereby obtaining a positive electrode plate used in this example.

[Preparation of Negative Electrode Plate]

A negative electrode active material mixture slurry was prepared by mixing 97.5 parts by mass of graphite as a negative electrode active material, 1.0 part by mass of carboxymethyl cellulose as a thickening agent, and 1.5 parts by mass of styrene-butadiene rubber (SBR) as a binding agent with an appropriate amount of water. This negative electrode active material mixture slurry was applied by the doctor blade method to both surfaces of a negative electrode substrate of copper with a thickness of 10 μm as follows: the applied weights on one surface was 11.3 mg/cm²; the applied weight on both surfaces was thus 22.6 mg/cm²; one surface had an applied portion of 284 mm and a bare portion of 33 mm; and the other surface had an applied portion of 226 mm and a bare portion of 91 mm Subsequently, the resultant object was dried through a drying machine, thereby forming a negative electrode active material layer on both surfaces of the negative electrode substrate. The resultant object was then compressed with a compression roller so that the thickness of the applied portions on both surfaces was 155 μm, thereby obtaining a negative electrode plate used in this example.

The potential of graphite at the time of charging is about 0.1 V relative to the Li reference. The packing amount of the active materials of the positive electrode and the negative electrode was adjusted such that the charge capacity ratio (negative electrode charge capacity/positive electrode charge capacity) of the positive electrode and the negative electrode is 1.1 at the potential of the positive electrode active material that is the design reference.

[Preparation of Electrolyte]

Lithium hexafluorophosphate (LiPF₆) was dissolved at 1 mol/L into a mixed solution in which ethylene carbonate (EC) and ethyl methyl carbonate (EMC) were mixed at a volume ratio of 3:7, and vinylene carbonate (VC) was added thereto at 1% by mass, thereby preparing the electrolyte used in this example.

[Preparation of Flattened Wound Electrode Assembly]

An aluminum lead and a nickel lead were welded to the positive electrode plate and the negative electrode plate, which were prepared as above, respectively. The positive electrode plate and the negative electrode plate were then wound into a flattened shape with a separator of a polyethylene microporous membrane interposed therebetween, thereby preparing a spiral electrode assembly used in this example.

[Preparation of Nonaqueous Electrolyte Battery]

The flattened wound electrode assembly prepared as above was enclosed into a laminate container, and the electrolyte obtained as above was poured thereto in a glove box filled with Ar. The pour hole was then closed, thereby preparing a nonaqueous electrolyte secondary battery (the design capacity was 800 mAh) according to this example.

### EXAMPLES 2 AND 3

Nonaqueous electrolyte secondary batteries of Examples 2 and 3 were prepared in the same manner as in Example 1, except for a point that the composition ratio of nickel, cobalt, and manganese in the lithium nickel cobalt manganese oxide was changed.

### EXAMPLES 4 TO 6

Nonaqueous electrolyte secondary batteries of Examples 4 to 6 were prepared in the same manner as in Example 1, except for the following: a mixture of the lithium nickel cobalt manganese oxide used in Example 1 or 2 and lithium cobalt oxide at a particular mixture ratio was used as the positive electrode active material; and in Example 6, the mixed amount of MoO₃ was changed to 0.01% by mass with respect to the positive electrode active material.

Lithium cobalt oxide as a positive electrode active material was obtained as follows. As starting materials, lithium carbonate (Li₂CO₃) was used as a lithium source. As a cobalt source, tricobalt tetroxide (Co₃O₄) was used that was obtained by baking cobalt carbonate at 550° C. and causing thermal decomposition reaction. These materials were weighed and mixed so as to give a molar ratio of 1:1 between lithium and cobalt. The mixture thus obtained was baked at 850° C. for 20 hours in an air atmosphere, thereby obtaining the lithium cobalt oxide. The lithium cobalt oxide was crushed with a mortar to have the average particle diameter of 15 μm, thereby obtaining the positive electrode active material. The chemical composition of the lithium cobalt oxide was measured using an inductively coupled plasma (ICP) emission spectrometry.

### EXAMPLES 7, 8 AND COMPARATIVE EXAMPLE 4

Nonaqueous electrolyte secondary batteries of Examples 7, 8, and Comparative Example 4 were prepared in the same manner as in Example 1, except for a point that the content of MoO₃ in the positive electrode active material mixture was changed.

### EXAMPLE 9

A nonaqueous electrolyte secondary battery of Example 9 was prepared in the same manner as in Example 1, except for a point that the molybdenum oxide added to the positive electrode active material mixture was changed to MoO₂.

### COMPARATIVE EXAMPLES 1 TO 3

Nonaqueous electrolyte secondary batteries of Comparative Examples 1 to 3 were prepared in the same manner as in Examples 1, 2, and 4, respectively, except for any molybdenum oxide was not added.

### COMPARATIVE EXAMPLES 5 AND 6

Nonaqueous electrolyte secondary batteries of Comparative Examples 5 and 6 were prepared without lithium nickel cobalt manganese oxide but only with lithium cobalt oxide as the positive electrode active material. The two comparative examples differ in that molybdenum oxide was added or not.

[Test of High-Voltage and High-Temperature Cycling Characteristics]

Tests of high-voltage and high-temperature cycling characteristics were conducted on the nonaqueous electrolyte secondary batteries according to respective examples and comparative examples, which were prepared as above, under the following conditions:
Charging: Constant current charging was performed with a current of 1.0 It (800 mA) until the battery voltage reached 4.4 V (the positive electrode potential was 4.5 V relative to the Li reference), and then charging was done with a constant voltage of 4.4 V until the current reached 1/20 It (40 mA);
Discharging: Constant current discharging was performed with a current of 1.0 It until the battery voltage reached 3.0 V (the positive electrode potential was 3.1 V relative to the Li reference);
Quiescence: The quiescence intervals between charging completion and discharging start and between discharging finish and charging start were each 10 minutes; and
Environmental temperature: The tests were conducted in a thermostatic chamber set to 45° C.

One cycle of charging and discharging consisted of charging, quiescence, discharging, and quiescence of the above-mentioned conditions in this order, and this charge-discharge cycle was repeated for 200 cycles. The discharge capacity on first cycle and the discharge capacity on 200th cycle were used in the following calculation formula to obtain the capacity retention ratio (%) after 200 cycles.

Capacity retention ratio (%) after 200 cycles=(Discharge capacity on 200th cycle/Discharge capacity on first cycle)×100

The battery thickness before and after the test of the cycling characteristics above was measured in each example and comparative example to obtain the increased amount of the battery thickness (the battery thickness after the cycling test minus the battery thickness before the cycling test) due to 200 charge-discharge cycles in a row.

Table 1 collectively shows the results of these tests.

TABLE 1

| | | | | Molybdenum oxide | | Capacity | Battery |
|---|---|---|---|---|---|---|---|
| | Positive electrode active material | | | | Mixed amount | retention | swelling |
| | Lithium nickel cobalt manganese oxide | | Content rate | | (% by mass to | ratio after | after 200 |
| | | Content rate | of LiCoO₂ | | positive electrode | 200 cycles | cycles |
| | Composition | (% by mass) | (% by mass) | Composition | active material) | (%) | (mm) |
| Example 1 | LiNi_{0.33}Co_{0.34}Mn_{0.33}O₂ | 100 | — | MoO₃ | 0.1 | 74 | 0.32 |
| Example 2 | LiNi_{0.5}Co_{0.2}Mn_{0.3}O₂ | 100 | — | MoO₃ | 0.1 | 77 | 0.36 |
| Example 3 | LiNi_{0.6}Co_{0.1}Mn_{0.3}O₂ | 100 | — | MoO₃ | 0.1 | 71 | 0.33 |
| Example 4 | LiNi_{0.33}Co_{0.34}Mn_{0.33}O₂ | 30 | 70 | MoO₃ | 0.1 | 78 | 0.28 |
| Example 5 | LiNi_{0.5}Co_{0.2}Mn_{0.3}O₂ | 30 | 70 | MoO₃ | 0.1 | 76 | 0.29 |
| Example 6 | LiNi_{0.33}Co_{0.34}Mn_{0.33}O₂ | 5 | 95 | MoO₃ | 0.01 | 81 | 0.26 |
| Example 7 | LiNi_{0.33}Co_{0.34}Mn_{0.33}O₂ | 100 | — | MoO₃ | 1.0 | 70 | 0.30 |
| Example 8 | LiNi_{0.33}Co_{0.34}Mn_{0.33}O₂ | 100 | — | MoO₃ | 2.0 | 69 | 0.29 |
| Example 9 | LiNi_{0.33}Co_{0.34}Mn_{0.33}O₂ | 100 | — | MoO₂ | 0.1 | 73 | 0.39 |
| Comparative | LiNi_{0.33}Co_{0.34}Mn_{0.33}O₂ | 100 | — | — | — | 33 | 1.10 |
| Example 1 | | | | | | | |
| Comparative | LiNi_{0.5}Co_{0.2}Mn_{0.3}O₂ | 100 | — | — | — | 30 | 1.22 |
| Example 2 | | | | | | | |
| Comparative | LiNi_{0.33}Co_{0.34}Mn_{0.33}O₂ | 30 | 70 | — | — | 40 | 1.31 |
| Example 3 | | | | | | | |
| Comparative | LiNi_{0.33}Co_{0.34}Mn_{0.33}O₂ | 100 | — | MoO₃ | 5.0 | 10 | 0.92 |
| Example 4 | | | | | | | |
| Comparative | LiCoO₂ | — | 100 | — | — | 87 | 0.23 |
| Example 5 | | | | | | | |
| Comparative | LiCoO₂ | — | 100 | MoO₃ | 0.1 | 85 | 0.22 |
| Example 6 | | | | | | | |

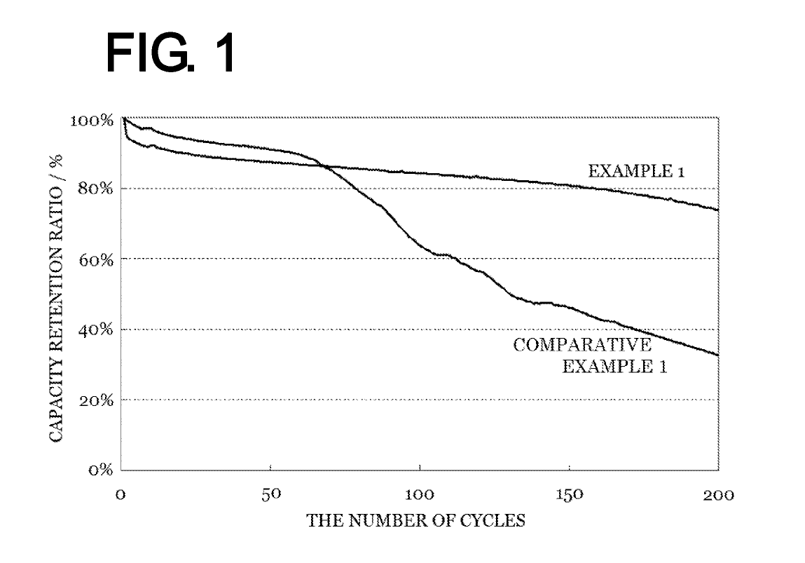

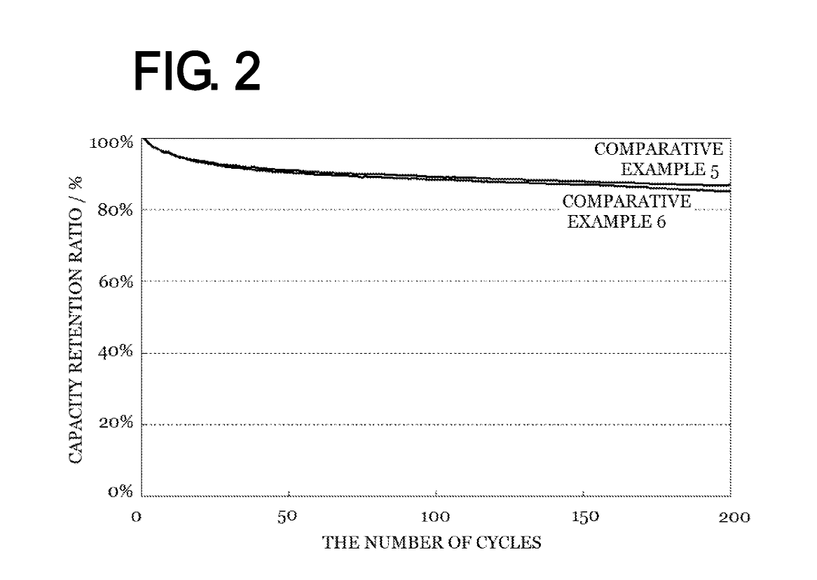

For Example 1 and Comparative Examples 1, 5, and 6, the discharge capacity was measure for each charge-discharge cycle to calculate the capacity retention ratio after each cycle, thereby checking the change in capacity drop associated with repetition of charge and discharge. FIG. 1 shows comparison between Example 1 and Comparative Example 1, and FIG. 2 shows comparison between Comparative Example 5 and Comparative Example 6.

The results in Table 1 and FIGS. 1 and 2 show the following. Specifically, the nonaqueous electrolyte secondary batteries of Examples 1 to 3, 7, and 8, which contained lithium nickel cobalt manganese oxide as the positive electrode active material and also contained molybdenum oxide in the positive electrode active material mixture, have a higher capacity retention ratio after 200 cycles and a lower increased amount of the battery thickness than those of Comparative Examples 1 and 2.

With reference to FIG. 1, Comparative Example 1, which contained no molybdenum oxide in the positive electrode active material mixture, shows a drastic capacity degradation during 50 to 100 cycles. This inflection point shows a timing at which the capacity ratio of the positive electrode and the negative electrode (=negative electrode charge capacity/positive electrode charge capacity) falls below 1. From this point, metal lithium is presumed to start precipitating on the negative electrode.

In contrast, Example 1 does not show a drastic capacity drop, and shows good cycling characteristics. This suggests that adding a molybdenum oxide to the positive electrode active material mixture prevents a collapse in the capacity balance in which the capacity ratio of the positive electrode and the negative electrode falls below 1, which means that the above-mentioned advantage of the invention is exerted.

In Comparative Examples 5 and 6, in which only lithium cobalt oxide was used as the positive electrode active material, adding molybdenum or not causes no difference in the capacity retention ratio after 200 cycles. FIG. 2 shows that a drastic capacity drop as seen in Comparative Example 1 did not occur in Comparative Example 5, in which no molybdenum oxide was contained in the positive electrode active material mixture, and there is no difference in cycling characteristics between Comparative Examples 5 and 6.

The reason for this is presumed to be the following: a side reaction at the time of charging is less likely to occur in the case of lithium cobalt oxide than lithium nickel cobalt manganese oxide; and dissolving cobalt is reduced and precipitates on the negative electrode, which prevents a collapse in the capacity balance as in the case of lithium nickel cobalt manganese oxide. As a result, the above-mentioned advantage of adding molybdenum to the positive electrode active material mixture is not exerted in the case of using only lithium cobalt oxide as the positive electrode active material.

Examples 4 to 6, in which a mixture of lithium nickel cobalt manganese oxide and lithium cobalt oxide was used as the positive electrode active material, show better cycling characteristics than Comparative Example 3. This shows that the above-mentioned advantage can be exerted also in the case of using a mixture of lithium nickel cobalt manganese oxide and lithium cobalt oxide. This suggests that the above-mentioned advantage of adding molybdenum to the positive electrode active material mixture can be exerted when the positive electrode active material contains at least lithium nickel cobalt manganese oxide, even as a mixture with other lithium-transition metal composite oxides such as lithium nickel oxide and lithium nickel cobalt oxide.

The lithium nickel cobalt manganese oxide has a lower true density than the lithium cobalt oxide, consequently being inferior in packing properties. For this reason, it is advantageous to use a mixture of the lithium nickel cobalt manganese oxide and, for example, lithium cobalt oxide, lithium nickel oxide, or nickel cobalt oxide, which has high packing properties, for achieving both high energy density and cost cutting of the positive electrode active material. The invention can be applied to such a case.

The result of Example 9 shows that the above-mentioned advantage of the invention can be effectively exerted in the case of the molybdenum oxide added being MoO₂.

The result of Example 6 shows that the advantage of the invention can be exerted when the additive amount of the molybdenum oxide to the positive electrode active material mixture is 0.01% by mass or larger with respect to the positive electrode active material. In contrast, Comparative Example 4 shows that it is not preferable to add the molybdenum oxide in an excessive amount, such as 5.0% by mass or larger with respect to the positive electrode active material, because the capacity retention ratio after 200 cycles extremely dropped in Comparative Example 4 although the battery swelling after 200 cycles is found to have been restrained compared with Comparative Examples 1 to 3.

The reason for this is presumed to be the following. Adding molybdenum oxide in an excessive amount results in a large amount of precipitation of molybdenum oxide (molybdenum ions) dissolving from the positive electrode. Consequently, the active sites of the negative electrode material are blocked, and the lithium intercalation reaction is inhibited.

The results of Examples 7 and 8 show that the extreme drop in the capacity retention ratio as above does not occur when the additive amount of molybdenum oxide is 2.0% by mass or smaller with respect to the positive electrode active material.

With interpolation using the results of Example 8 and Comparative Example 4, the additive amount of molybdenum oxide to the positive electrode active material mixture is preferably around 3.0% by mass with respect to the positive electrode active material with respect to the positive electrode active material.

1.-4. (canceled)

5. A nonaqueous electrolyte secondary battery comprising:
a positive electrode plate including a positive electrode active material mixture layer that contains a positive electrode active material capable of absorbing and desorbing lithium ions;
a negative electrode plate including a negative electrode active material mixture layer that contains a negative electrode active material capable of absorbing and desorbing lithium ions; and
a nonaqueous electrolyte,
the positive electrode active material containing 1% by mass or larger of a lithium nickel cobalt manganese oxide represented by LiₐNiₓCo_{y}Mn_{1-x-y}O₂ (0.9≦a≦1.1, 0<x<1, 0<y<1, 2x≧1−y), and
the positive electrode active material mixture layer containing 0.01 to 3.0% by mass of a molybdenum oxide (MoO_{z}; 2≦z≦3) with respect to the lithium nickel cobalt manganese oxide.

6. The nonaqueous electrolyte secondary battery according to claim 5, wherein the positive electrode active material is a mixture of a lithium nickel cobalt manganese oxide with at least one kind selected from a lithium cobalt oxide, a lithium nickel oxide, and a lithium nickel cobalt oxide.

7. The nonaqueous electrolyte secondary battery according to claim 5, wherein the negative electrode active material is graphite.

8. The nonaqueous electrolyte secondary battery according to claim 6, wherein the negative electrode active material is graphite.

9. The nonaqueous electrolyte secondary battery according to claim 5, wherein the charging voltage of the positive electrode plate is 4.40 V or larger relative to the Li reference.

10. The nonaqueous electrolyte secondary battery according to claim 6, wherein the charging voltage of the positive electrode plate is 4.40 V or larger relative to the Li reference.

11. The nonaqueous electrolyte secondary battery according to claim 7, wherein the charging voltage of the positive electrode plate is 4.40 V or larger relative to the Li reference.

12. The nonaqueous electrolyte secondary battery according to claim 8, wherein the charging voltage of the positive electrode plate is 4.40 V or larger relative to the Li reference.
